(19) United States
(12) Patent Application Publication
(10) Pub. No.: US 2021/0199775 A1
(43) Pub. Date: Jul. 1, 2021

(54) MICROMACHINED MIRROR ASSEMBLY WITH PIEZOELECTRIC ACTUATOR

(71) Applicant: Voyager (HK) Co., Ltd., Beijing (CN)

(72) Inventors: Youmin Wang, Mountain View, CA (US); Yufeng Wang, Mountain View, CA (US); Sergio Fabian Almeida Loya, Mountain View, CA (US); Qin Zhou, Mountain View, CA (US); Gary Li, Mountain View, CA (US); George Lee, Mountain View, CA (US); Bruce Sun, Mountain View, CA (US)

(73) Assignee: Voyager (HK) Co., Ltd., Beijing (CN)

(21) Appl. No.: 16/732,103

(22) Filed: Dec. 31, 2019

(51) Int. Cl. G01S 7/481; G02B 26/08

(52) U.S. Cl. CPC G01S 7/4817; G02B 26/0858

(57) ABSTRACT

Embodiments of the disclosure provide a micromachined mirror assembly for controlling directions of optical signals in an optical sensing system. The micromachined mirror assembly includes a micro mirror and at least one piezoelectric actuator. The micro mirror is suspended over a substrate by at least one beam mechanically coupled to the micro mirror, and the at least one piezoelectric actuator is mechanically coupled to the at least one beam and is configured to drive the micro mirror via the at least one beam. The at least one piezoelectric actuator is configured to drive the micro mirror to tilt around a first axis based on a first electrical signal applied to the at least one piezoelectric actuator. The first electrical signal causes a piezoelectric material of the at least one piezoelectric actuator to expand in a first direction in parallel with the first axis.

### TECHNICAL FIELD

The present disclosure relates to optical sensing systems such as a light detection and ranging (LiDAR) system, and more particularly to, a micromachined mirror assembly for controlling directions of optical signals in such an optical sensing system.

### BACKGROUND

Optical sensing systems such as LiDAR systems have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor such as a photodetector or a photodetector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The pulsed laser light beams emitted by a LiDAR system are typically directed to multiple directions to cover a field of view (FOV). Various methods can be used to control the directions of the pulsed laser light beams. Existing LiDAR systems generally use electric- or magnetic-based driving methods to steer optical components in the LiDAR systems to direct the pulsed laser light beams to the surrounding environment. However, both electric- or magnetic-based driving methods have drawbacks. Electric-based methods often suffer from weak driving forces and thus limit the size of the FOV. Magnetic-based methods may provide larger driving forces but require complex assembling processes. In addition, the cost of implementing the magnetic-based methods is usually high.

Embodiments of the disclosure improve the performance and reduce the cost of optical sensing systems such as LiDAR systems by providing a micromachined mirror assembly driven by piezoelectric actuator(s).

### SUMMARY

Embodiments of the disclosure provide a micromachined mirror assembly for controlling directions of optical signals in an optical sensing system. The micromachined mirror assembly includes a micro mirror and at least one piezoelectric actuator. The micro mirror is suspended over a substrate by at least one beam mechanically coupled to the micro mirror. The at least one piezoelectric actuator is mechanically coupled to the at least one beam and is configured to drive the micro mirror via the at least one beam. The at least one piezoelectric actuator is configured to drive the micro mirror to tilt around a first axis based on a first electrical signal applied to the at least one piezoelectric actuator. The first electrical signal causes a piezoelectric material of the at least one piezoelectric actuator to expand in a first direction in parallel with the first axis.

Embodiments of the disclosure also provide a method for controlling a micromachined mirror assembly. The method includes suspending a micro mirror over a substrate by at least one beam mechanically coupled to the micro mirror and mechanically coupling at least one piezoelectric actuator to the at least one beam. The method further includes applying a first electrical signal to the at least one piezoelectric actuator to cause a piezoelectric material of the at least one piezoelectric actuator to expand in a first direction in parallel with the first axis.

Embodiments of the disclosure further provide an optical sensing system. The optical sensing system includes a transmitter, a receiver, and a mirror assembly. The transmitter is configured to emit optical signals in a plurality of directions. The receiver is configured to detect reflected optical signals. The mirror assembly is configured to control the directions of the emitted optical signals. The mirror assembly includes a micro mirror and at least one piezoelectric actuator. The micro mirror is suspended over a substrate by at least one beam mechanically coupled to the micro mirror. The at least one piezoelectric actuator is mechanically coupled to the at least one beam and is configured to drive the micro mirror via the at least one beam. The at least one piezoelectric actuator is configured to drive the micro mirror to tilt around a first axis based on a first electrical signal applied to the at least one piezoelectric actuator. The first electrical signal causes a piezoelectric material of the at least one piezoelectric actuator to expand in a first direction in parallel with the first axis.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3A illustrates a schematic diagram of an exemplary micromachined mirror assembly, according to embodiments of the disclosure.

FIG. 3B illustrates a section view along line A-A′ of the exemplary micromachined mirror assembly in FIG. 3A, according to embodiments of the disclosure.

FIG. 3C illustrates a section view along line B-B′ of the exemplary micromachined mirror assembly in FIG. 3A, according to embodiments of the disclosure.

FIG. 3D illustrates a section view along line C-C′ of the exemplary micromachined mirror assembly in FIG. 3A, according to embodiments of the disclosure.

FIG. 4A illustrates a section view of an exemplary piezoelectric actuator, according to embodiments of the disclosure.

FIG. 4B illustrates a section view of another exemplary piezoelectric actuator, according to embodiments of the disclosure.

FIG. 5 illustrates the relationship between the polarization direction, the electrical signal and the expansion direction of an exemplary piezoelectric material working in a transversal mode, according to embodiments of the disclosure.

FIG. 6 illustrates a schematic diagram of another exemplary micromachined mirror assembly, according to embodiments of the disclosure.

FIG. 7A illustrates waveforms of an exemplary set of voltage signals applied to the piezoelectric actuators of a micromachined mirror assembly, according to embodiments of the disclosure.

FIG. 7B illustrates waveforms of another set of exemplary voltage signals applied to the piezoelectric actuators of a micromachined mirror assembly, according to embodiments of the disclosure.

FIG. 8 illustrates a flow chart of an exemplary method for controlling directions of optical signals in the micromachined mirror assembly, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for controlling directions of optical signals in an optical sensing system (e.g., a LiDAR system) using a mirror assembly having a mirror driven by one or more piezoelectric actuators. For example, the mirror can be driven by the piezoelectric actuator(s) to tilt certain angles around an axis, thereby directing (e.g., guiding, reflecting, inflecting, and/or diffracting) incident laser beams from a laser source towards certain directions to, for example, scan an FOV. The mirror can be a single micro mirror, or an array of micro mirrors integrated into a micromachined mirror assembly made from semiconductor materials using microelectromechanical system (MEMS) technologies. Conventionally, MEMS-based micro mirrors are actuated by electrostatic or magnetic actuators. As discussed above, magnetic actuators, while providing relatively large actuation force, are complicated to assemble. In addition, the cost of constructing a magnetic actuator is high. Electrostatic actuators, on the other hand, provide relatively weak driving force. This problem of insufficient driving force may become more severe when a large-sized mirror with a large aperture is needed.

In addition, to control the tilting angle of the mirror, a close control loop is normally needed, which requires accurate measurement of the position of mirror. The measurement of the position is often implemented by an electromagnetic signal-based position sensor, and the sensing signal of such a device may be interfered by the driving signals generated by an electric or magnetic actuator. A piezoelectric actuator can decouple the driving and sensing signals, providing superior performance than the electric and magnetic counterparts. Moreover, the driving force generated by a piezoelectric actuator can be sufficiently large to drive large-size mirrors.

When driving the mirror to tilt around an axis, a piezoelectric material of a conventional piezoelectric actuator expands in a longitudinal mode, where the displacement is perpendicular to an axis which the mirror can tilt around (hereafter tilting axis). As a result, the displacement of the piezoelectric material creates a force that directly tilts the mirror around the tilting axis. However, the displacement generated by the piezoelectric material when working in the longitudinal mode is relatively small. The limited displacement provided by the piezoelectric actuator may cause a limited tilting angle of the mirror and a limited scanning angle of the emitted light as a result. This may in turn reduce the FOV generated by the LiDAR system.

Consistent with the present disclosure, a piezoelectric actuator with a piezoelectric material working in a transversal mode (d₃₁ mode) is used. Unlike the piezoelectric material working in the longitudinal mode, a piezoelectric material working in a transversal mode expands in the direction in parallel with the tilting axis. The piezoelectric actuator is further designed to have its two ends along the tilting axis fixed, thus preventing a displacement in the direction parallel to the tilting axis. For example, the actuator is attached to a rigid electrode that is non-expandable. As a result, the expansion force along the tilting axis causes the piezoelectric material to bend in the direction perpendicular to the tilting axis. The displacement caused by the bending of the piezoelectric material in the longitudinal direction may then be used for driving the mirror to tilt around the axis.

Since the piezoelectric material working in the transversal mode (d₃₁) can provide a much larger, and a more stable displacement than the piezoelectric material working in other modes (e.g., longitudinal mode (d₃₃) and/or shear mode (d₁₅)), micro mirrors can be driven by the disclosed piezoelectric actuator to direct lights in a wider range of directions accordingly.

Embodiments of the present disclosure improve the performance and lower the cost of an optical sensing system, which can be used in many applications. For example, the improved optical sensing system can be used in advanced navigation technologies, such as to aid autonomous driving or to generate high-definition maps, in which the optical sensing system can be equipped on a vehicle.

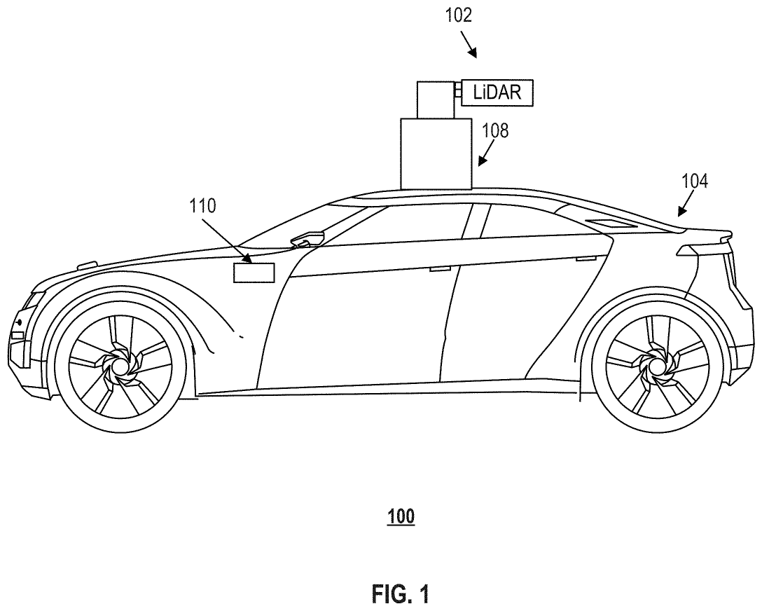

For example, FIG. 1 illustrates a schematic diagram of an exemplary vehicle 100 equipped with an optical sensing system (e.g., a LiDAR system) 102 (hereinafter also referred to as LiDAR system 102), according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with pulsed laser beam and measuring the reflected pulses with a receiver. The laser beam used for LiDAR system 102 may be ultraviolet, visible, or near infrared. In some embodiments of the present disclosure, LiDAR system 102 may capture point clouds including depth information of the objects in the surrounding environment. As vehicle 100 moves along the trajectory, LiDAR system 102 may continuously capture data. Each set of scene data captured at a certain time range is known as a data frame.

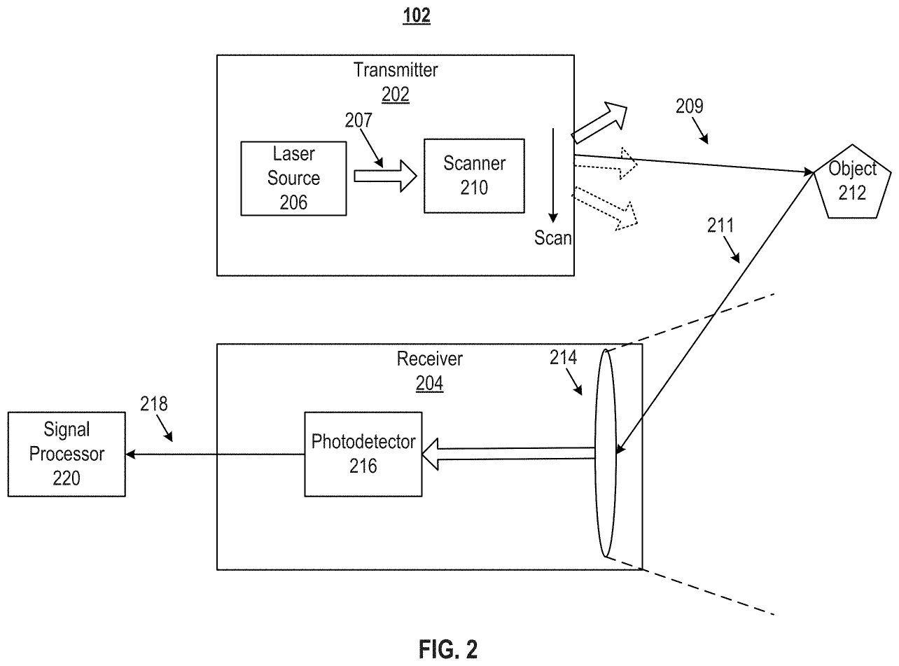

FIG. 2 illustrates a block diagram of an exemplary LiDAR system 102, according to embodiments of the disclosure. LiDAR system 102 may include a transmitter 202 and a receiver 204. Transmitter 202 may emit laser beams along multiple directions. Transmitter 202 may include one or more laser sources 206 and a scanner 210. As will be described below in greater detail, scanner 210 may include a micromachined mirror assembly having a micro mirror driven by piezoelectric actuator(s).

Transmitter 202 can sequentially emit a stream of pulsed laser beams in different directions within a scan range (e.g., a range in angular degrees), as illustrated in FIG. 2. Laser source 206 may be configured to provide a laser beam 207 (also referred to as “native laser beam”) to scanner 210. In some embodiments of the present disclosure, laser source 206 may generate a pulsed laser beam in the ultraviolet, visible, or near infrared wavelength range.

In some embodiments of the present disclosure, laser source 206 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction. In some embodiments of the present disclosure, a PLD includes a PIN diode in which the active region is in the intrinsic (I) region, and the carriers (electrons and holes) are pumped into the active region from the N and P regions, respectively. Depending on the semiconductor materials, the wavelength of incident laser beam 207 provided by a PLD may be smaller than 1,100 nm, such as 405 nm, between 445 nm and 465 nm, between 510 nm and 525 nm, 532 nm, 635 nm, between 650 nm and 660 nm, 670 nm, 760 nm, 785 nm, 808 nm, or 848 nm. It is understood that any suitable laser source may be used as laser source 206 for emitting laser beam 207.

Scanner 210 may be configured to emit a laser beam 209 to an object 212 in a first direction. Object 212 may be made of a wide range of materials including, for example, non-metallic objects, rocks, rain, chemical compounds, aerosols, clouds and even single molecules. The wavelength of laser beam 209 may vary based on the composition of object 212. In some embodiments, at each time point during the scan, scanner 210 may emit laser beam 209 to object 212 in a direction within a range of scanning angles by rotating the micromachined mirror assembly. In some embodiments of the present disclosure, scanner 210 may also include optical components (e.g., lenses, mirrors) that can focus pulsed laser light into a narrow laser beam to increase the scan resolution and the range to scan object 212.

In some embodiments, receiver 204 may be configured to detect a returned laser beam 211 returned from object 212. The returned laser beam 211 may be in a different direction from beam 209. Receiver 204 can collect laser beams returned from object 212 and output electrical signals reflecting the intensity of the returned laser beams. Upon contact, laser light can be reflected by object 212 via backscattering, such as Rayleigh scattering, Mie scattering, Raman scattering, and fluorescence. As illustrated in FIG. 2, receiver 204 may include a lens 214 and a photodetector 216. Lens 214 may be configured to collect light from a respective direction in its field of view (FOV). At each time point during the scan, returned laser beam 211 may be collected by lens 214. Returned laser beam 211 may be returned from object 212 and have the same wavelength as laser beam 209.

Photodetector 216 may be configured to detect returned laser beam 211 returned from object 212. In some embodiments, photodetector 216 may convert the laser light (e.g., returned laser beam 211) collected by lens 214 into an electrical signal 218 (e.g., a current or a voltage signal). Electrical signal 218 may be generated when photons are absorbed in a photodiode included in photodetector 216. In some embodiments of the present disclosure, photodetector 216 may include a PIN detector, a PIN detector array, an avalanche photodiode (APD) detector, a APD detector array, a single photon avalanche diode (SPAD) detector, a SPAD detector array, a silicon photo pultiplier (SiPM/MPCC) detector, a SiP/MPCC detector array, or the like.

While scanner 210 is described as part of transmitter 202, it is understood that in some embodiments, scanner 210 can be part of receiver 204, e.g., before photodetector 216 in the light path. The inclusion of scanner 210 in receiver can ensure that photodetector 216 only captures light, e.g., returned laser beam 211 from desired directions, thereby avoiding interferences from other light sources, such as the sun and/or other LiDAR systems. By increasing the aperture of mirror assembly in scanner 210 in receiver 204, the sensitivity of photodetector 216 can be increased as well.

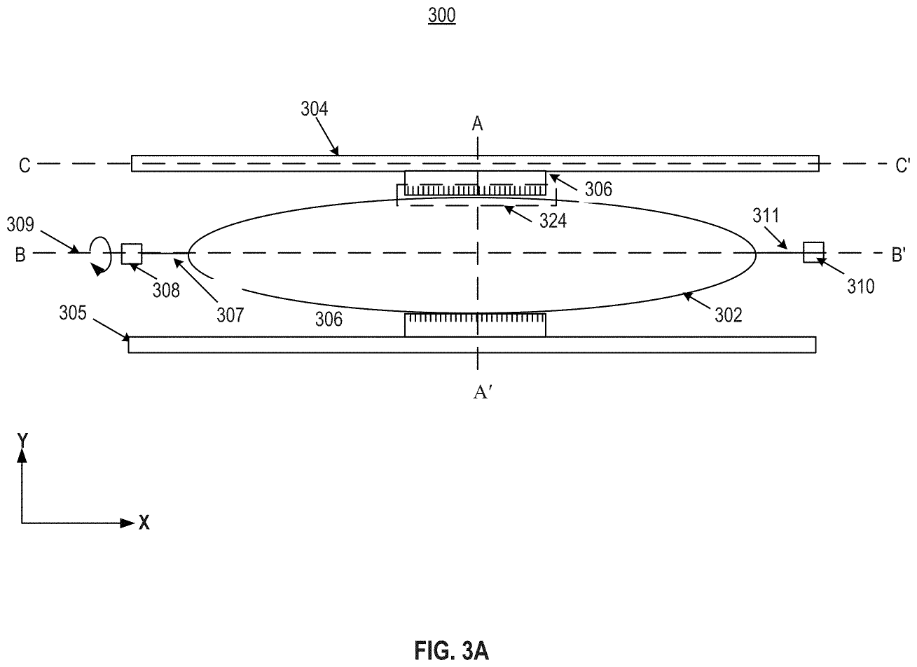

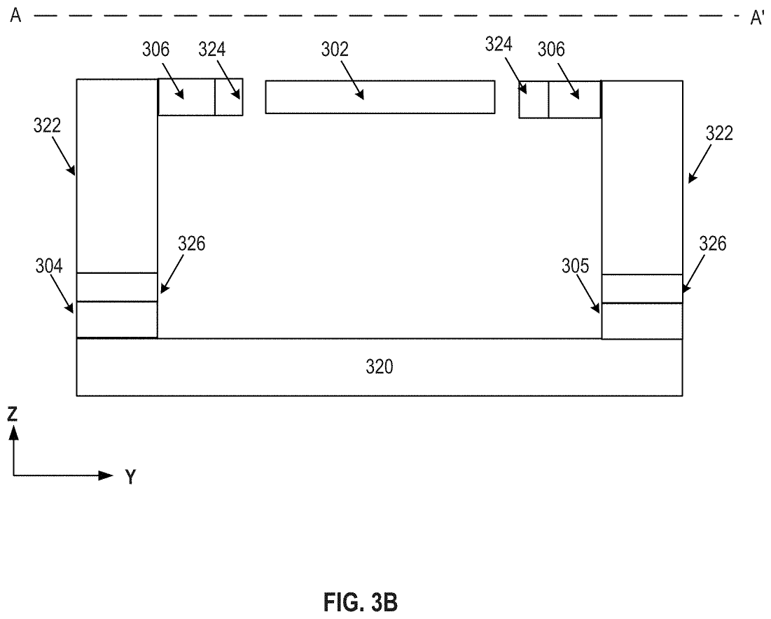

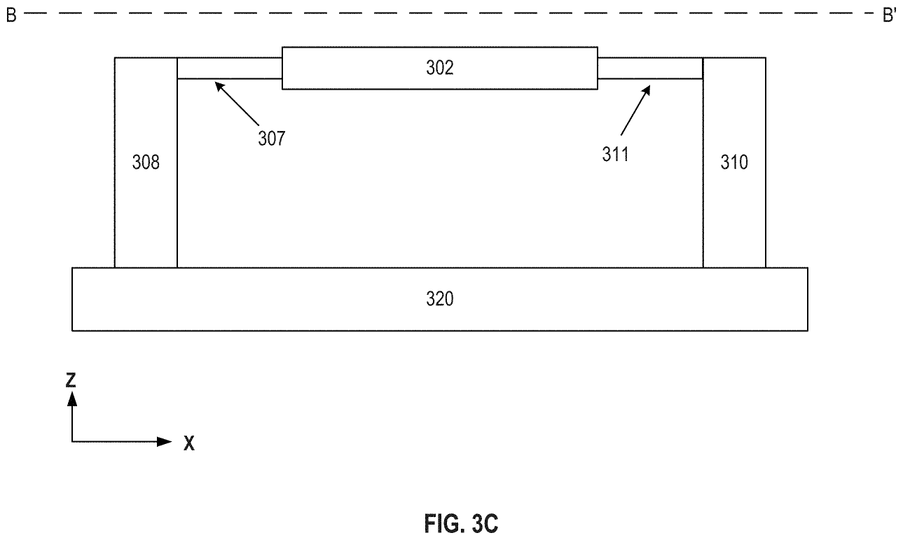

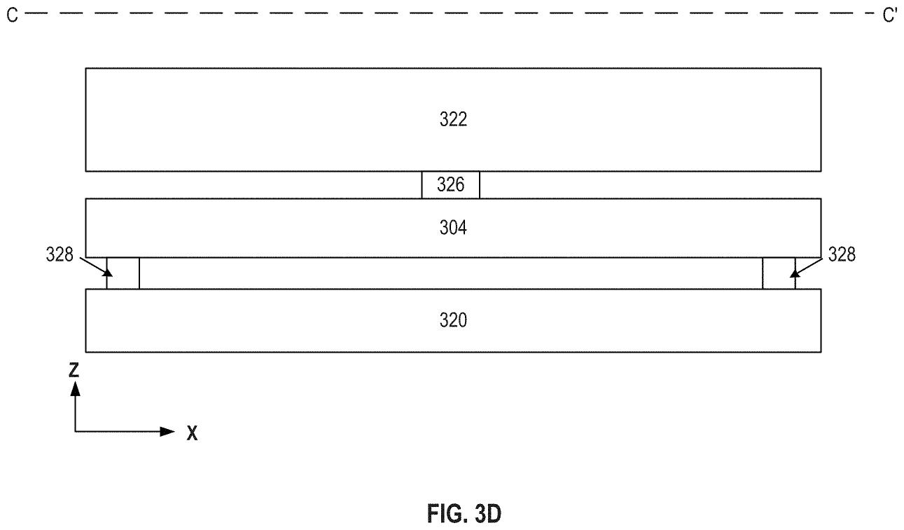

In some embodiments, the incident angle of laser beam 207 may be fixed relative to scanner 210, and the scanning of laser beam 209 may be achieved by rotating (e.g., tilting) a micro mirror or an array of micro mirrors assembled in scanner 210. FIG. 3A illustrates a schematic diagram of an exemplary micromachined mirror assembly 300, according to embodiments of the disclosure. FIG. 3B illustrates a section view along line A-A′ of micromachined mirror assembly 300 shown in FIG. 3A, according to embodiments of the disclosure. FIG. 3C illustrates a section view along line B-B′ of micromachined mirror assembly 300 shown in FIG. 3A, according to embodiments of the disclosure. FIG. 3D illustrates a section view along line C-C′ of micromachined mirror assembly 300 shown in FIG. 3A, according to embodiments of the disclosure. Different from an electrostatic micro-mirror that has weak driving force, the micromachined mirror assembly 300 shown in FIG. 3A uses one or more piezoelectric actuators working in a bending mode with the piezoelectric material therein working in the transversal mode (d₃₁). The piezoelectric material expands in a first direction in parallel with the titling axis of the micromachined mirror assembly. The expansion of the piezoelectric material may cause the piezoelectric actuator to bend in a second direction, perpendicular to the titling axis and the first direction. The displacement caused by the bending may be used to drive the micromachined mirror assembly to tilt around the tilting axis.

As illustrated in FIGS. 3A-3D, micromachined mirror assembly 300 may include a micro mirror 302 and a pair of piezoelectric actuators 304 and 305. In some embodiments, micromachined mirror assembly 300 may include only one piezoelectric actuator or more than two piezoelectric actuators. A first beam 307 is mechanically coupled to one side of micro mirror 302, and a second beam 311 is mechanically coupled to the opposite side of micro mirror 302. Micro mirror 302 may be suspended over a substrate 320 (as shown in FIGS. 3B and 3C) by beams 307 and 311 to allow limited movement. For example, micro mirror 302 may be configured to tilt around a tilting axis 309 (also referred to as axis 309). Axis 309 may be defined by beams 307 and 311, as micro mirror 302 may tilt due to the rotation of beams 307 and 311. In some embodiments, micro mirror 302 may be covered by a reflective layer disposed on its top surface (e.g., facing incident laser beam(s)). The reflective layer may form a reflective surface to reflect an incident laser beam, thereby forming a reflected laser beam. By tilting micro mirror 302 to a different angle, the incident laser beam may be reflected to a different direction, forming another reflected laser beam. It is to be understood that although micro mirror 302 is in an eclipse shape as shown in FIG. 3A, the shape of micro mirror 302 is not limited to an eclipse shape, and may vary in other examples, such as a square, round, or rectangular shape.

Micromachined mirror assembly 300 may further include first and second anchors 308 and 310, each mechanically coupled to a respective end of beam 307 and 311 that is farther away from micro mirror 302, along axis 309. The other end of beams 307 and 311 is mechanically coupled to micro mirror 302. In some embodiments, each one of beams 307 and 311 is configured to rotate around axis 309, thereby driving micro mirror 302 to tilt around axis 309. In some embodiments, anchors 308 and/or 310 may be rigidly coupled to piezoelectric actuator 304 and/or 305 such that any motion or displacement generated by piezoelectric actuator 304 and/or 305 can be transferred to anchor 308 and/or 310. For example, anchor 308 and/or 310 and piezoelectric actuator 304 and/or 305 may be both disposed on substrate 320 using MEMS microfabrication techniques.

In some embodiments, piezoelectric actuator 304/305 may work in a bending mode to create the displacement. For example, when working in the bending mode (i.e., the piezoelectric material of the piezoelectric actuator 304 working in the (d₃₃) mode), piezoelectric actuator 304 may bend to provide the displacement for driving anchors 308 and/or 310, when receiving a first electrical signal. The first electrical signal may cause an electrical field in the piezoelectric material perpendicular to axis 309. In some embodiments, when the polarization of the piezoelectric material is also perpendicular to axis 309, applying the electrical field to the piezoelectric material will cause the piezoelectric material to expand along axis 309).

In some embodiments, piezoelectric actuator 304/305 may further include a rigid (i.e., non-expandable) electrode being attached to the piezoelectric material. As a result, the expansion along the tilting axis caused by the first electric signal is prohibited by the rigid electrodes. The transversal force therefore translates into a longitudinal force to bend the piezoelectric actuator in the direction perpendicular to the tilting axis. The displacement caused by the bending may be then used to drive anchor 308 and/or 310 for titling micro mirror 302. The mechanism will be disclosed in greater details below.

In some embodiments, the bending displacement generated by piezoelectric actuator 304 (e.g., in a direction perpendicular to the paper surface of FIG. 3A and in the vertical direction in FIGS. 3B-3D) is transferred to anchors 308 and 310, causing a displacement of anchors 308 and 310 (e.g., tilting up and down when observing FIG. 3A from the top). The displacement of anchors 308 and 310 may further cause beams 307 and 311 to rotate (e.g., twist) around axis 309.

Similarly, when piezoelectric actuator 305 receives a second electric signal, the resulting bending can also be transferred to beams 307 and 311. The rotation motions of beams 307 and 311 caused by piezoelectric actuators 304 and 305 can be superimposed, either enhancing or reducing each other. For example, when the first and second electric signals have the same frequency and opposite phases (e.g., having a 180-degree phase difference), piezoelectric actuator 304 moves upwards (i.e., bending upwards) and piezoelectric actuator 305 moves downwards (i.e., bending downwards), thus enhancing the tilting of anchors 308 and 310. Setting a phase difference other than 180 degrees may also achieve the tilting enhancement effect, but to a lesser degree. In an extreme case, when the first and second electric signals are in phase (zero phase difference), anchors 308 and 310 may not tilt at all because the twisting forces resulting from the bending movements of piezoelectric actuators 304 and 305 cancel each other out. As beams 307 and 311 rotate/twist around axis 309, micro mirror 302 would be driven to tilt correspondingly. In this way, when piezoelectric actuators 304 and 305 receive electrical signals, they drive micro mirror 302 to tilt around axis 309.

In some embodiments, micromachined mirror assembly 300 may also include one or more position sensor 306 configured to detect the position of micro mirror 302. The detected position of micro mirror 302 may further be used to control a titling angle of micro mirror 302. As shown in FIGS. 3A and 3B, each position sensor 306 may include a stator 322 attached to a respective piezoelectric actuator (e.g., 304 or 305). Position sensor 306 may include a comb structure 324 comprising a plurality of teeth. The teeth may be interleaved with a corresponding plurality of teeth on micro mirror 302, as shown in FIG. 3A. When piezoelectric actuator 304/305 receives electrical signals to drive micro mirror 302 (e.g., tilting micro mirror 302), there would be relative movements between stator 322 and micro mirror 302, causing the overlapping portion between the interleaved teeth of position sensor 306 and micro mirror 302 to change. This change can generate a signal for position sensor 306 to detect the position of micro mirror 302. It is to be understood that the structure of position sensor 306 shown in FIGS. 3A and 3B is exemplary only, and other types of position sensor may be used to detect the position of micro mirror 302.

In some embodiments, the position of micro mirror 302 detected by position sensor 306 may be used to control a tilting angle of micro mirror 302 when scanning the incident lights. For example, the tilting angle of micro mirror 302 may be controlled to reflect the incident light at a certain direction based on the detected position. The controlled reflection angle of the incident lights may be used to scan different FOVs.

Because micro mirror 302 is driven by the mechanical motion of piezoelectric actuator(s) instead of electrical force found in conventional mirror assemblies, position sensor 306 would not suffer from electrical interference caused by electrical actuator(s). As a result, both sensitivity and accuracy of position sensing can be improved.

In some embodiments, as shown in FIGS. 3B and 3D, micromachined mirror assembly 300 may also include one or more epoxy 326 for connecting stator 322 and piezoelectric actuator 304 (also for connecting stator 322 and actuator 305, not shown). In some embodiments, epoxy 326 may be epoxy resins, such as novolac epoxy resins, bisphenol-based epoxy resins, aliphatic epoxy resins, halogenated epoxy resins, glycidylamine epoxy resins, etc. It is contemplated that epoxy 326 may be any suitable adhesive materials that has the suitable modulus of rigidity and can be used to fix stator 322 and piezoelectric actuator 304/305. Piezoelectric actuator 304/305 may further be fixed to substrate 320 through one or more anchors 328.

It is to be contemplated that although piezoelectric actuator 304 shown in FIG. 3D is fixed to substrate 320 at two ends (e.g., through two anchors 328), other fixing methods (i.e., other boundary conditions) may also be used to provide support (i.e., for providing fulcrum(s)) to piezoelectric actuator 304/305. For example, piezoelectric actuator 304 may be fixed to substrate 320 through one anchor 328 at one end, and the other end of actuator 304 is free to move. When working in the bending mode, as the expansion along the tilting axis is prohibited by the rigid electrodes, the transversal force may translate into a longitudinal force to bend piezoelectric actuator 304 as well as a tilting force to tilt piezoelectric actuator 304 in the direction perpendicular to the tilting axis (e.g., the free end of piezoelectric actuator 304 may tilt upward). Combining the bending displacement and the tilting displacement, piezoelectric actuator 304 in this embodiment may provide an even larger displacement than the two fixing point embodiments shown in FIG. 3D when working in the bending mode.

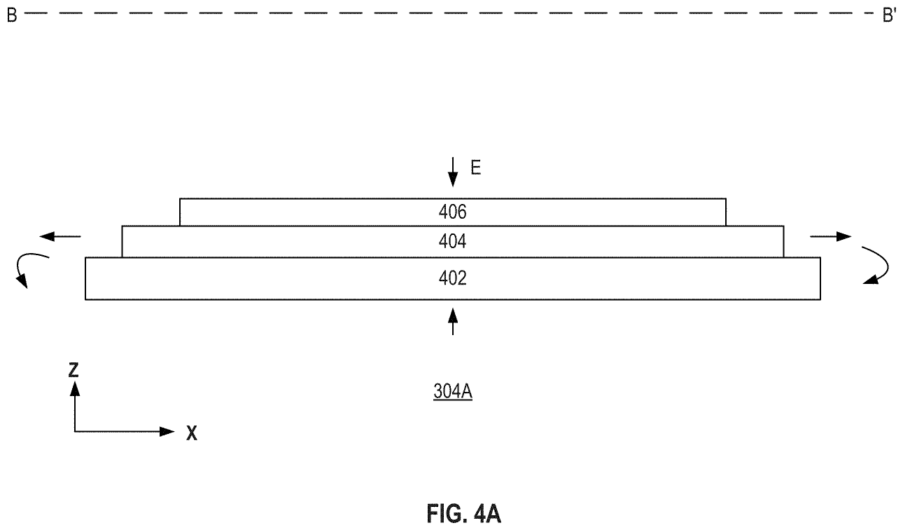

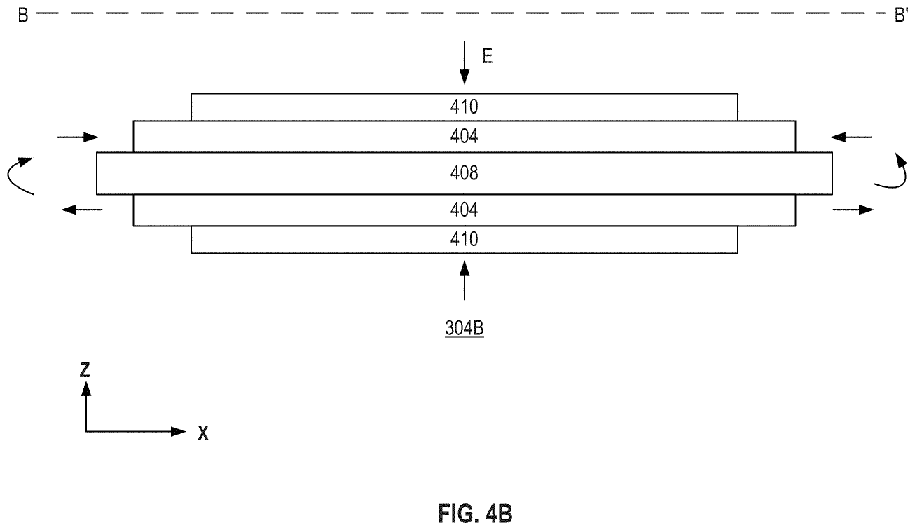

FIGS. 4A and 4B illustrate a section view of two exemplary piezoelectric actuators, according to embodiments of the disclosure. In some Embodiments, as illustrated in FIG. 4A, piezoelectric actuator 304/305 may be an unimorph piezoelectric actuator. For example, piezoelectric actuator 304A may include a bottom electrode 402 and a top electrode 406, being fixed and electrically connected to a piezoelectric material 404, configured to provide the electric signal to piezoelectric material 404. For example, the electrical signal (i.e., a voltage) applied to piezoelectric material 404 through bottom electrode 402 and top electrode 406 may cause an electrical field between the two sides of piezoelectric material 404.

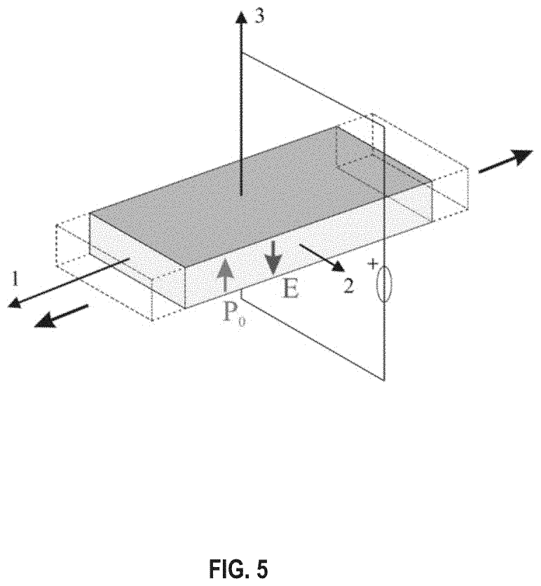

When working in the transversal mode (i.e., the bending mode for piezoelectric actuator 304/305), piezoelectric material 404 may expand in a direction perpendicular to the direction of the polarization and the direction of the electrical field caused by the electrical signal. For example, as shown in FIG. 5, where E is the electrical filed caused by the first electrical signal being applied to piezoelectric material 404, and Po is the polarization direction of piezoelectric material 404. When the electrical filed E is in a first direction (e.g., in 3 axis), parallel to the polarization of piezoelectric material 404, piezoelectric material 404 may expand in a second direction (e.g., in 1 axis), perpendicular to the first direction.

Back to FIG. 4A, when applying the first electric signal to piezoelectric material 404 through bottom electrode 402 and top electrode 406 in Z axis, piezoelectric material 404 may expand/extend in X axis. In some embodiments, only one of bottom electrode 402 or top electrode 406 is designed to be non-expandable. For example, one of the electrodes attached to the actuator is rigid, therefore prohibiting the expansion of piezoelectric material 404, while the other electrode attached to the actuator may be expandable, thus allowing piezoelectric material 404 to bend freely. As a result, the electrodes and the piezoelectric material combination (i.e., piezoelectric actuator 304/305) may bend in Z axis, perpendicular to the expansion of piezoelectric material 404. The displacement of piezoelectric actuator 304A in the Z axis caused by the bending may drive the rotation of anchors 308/310.

FIG. 4B illustrates a section view of another exemplary piezoelectric actuator 304B, according to embodiments of the disclosure. In some embodiments, piezoelectric actuator 304/305 may be a bimorph piezoelectric actuator that includes two pieces of piezoelectric material 404, interleaved between two top electrodes 410 and a middle electrode 408. Similar to piezoelectric actuator 304A shown in FIG. 4A, when working in the bending mode, the two pieces of piezoelectric material 404 of piezoelectric actuator 304B may tend to expand in X axis and thus causing piezoelectric actuator 304B to bend in Z axis. In some embodiments, one piece of piezoelectric material 404 of piezoelectric actuator 304B is expanding, and the other is shrinking. For example, positive voltages may be applied on the two pieces of piezoelectric material 404 respectively at two top electrodes 410, and middle electrode 408 may be connected to the ground, to generate opposite electric fields within the two pieces of piezoelectric material 404. The two pieces of piezoelectric material 404 may have the same direction of polarization. In this way, piezoelectric actuator 304B may provide even larger displacement comparing to unimorph piezoelectric actuator 304A when used for driving micro mirror 302.

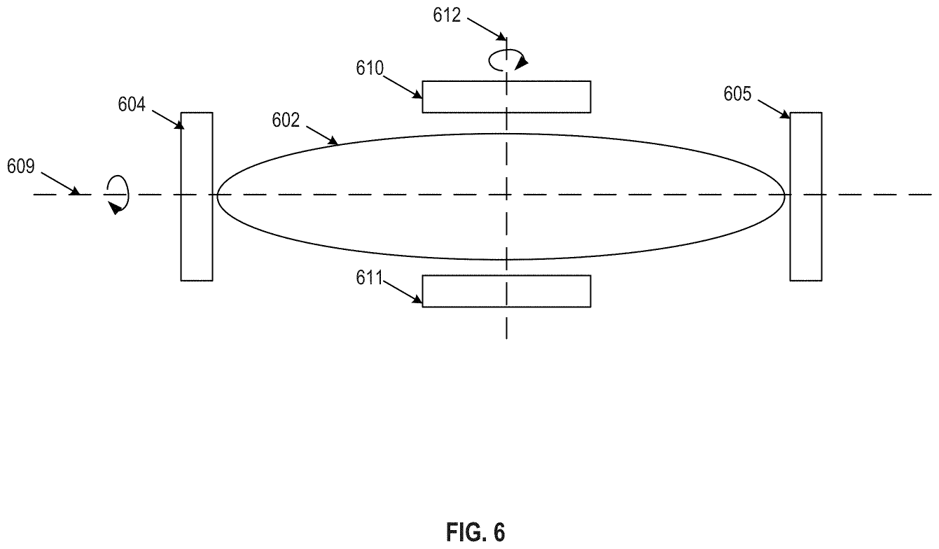

In some embodiments, in order to enable micro mirror 302 to tilt in multiple directions, multiple sets of piezoelectric actuators can be used. As shown in FIG. 6, a first set of piezoelectric actuators comprises piezoelectric actuators 610 and 611. When piezoelectric actuators 610 and 611 receive electric signals, they cause a micro mirror 602 to tilt around a first axis 609. A second set of piezoelectric actuators comprises piezoelectric actuators 604 and 605. When piezoelectric actuators 604 and 605 receive electric signals, they cause micro mirror 602 to tilt around a second axis 612. In some embodiments, axis 609 may be perpendicular to axis 612. In some embodiment, one set of actuators may be disposed on a first substrate to drive micro mirror 602 to tilt around one axis, while micro mirror 602 may be driven by a different set of actuators disposed on a second substrate to tilt around another axis, thereby achieving tilting of micro mirror 602 along multiple axes.

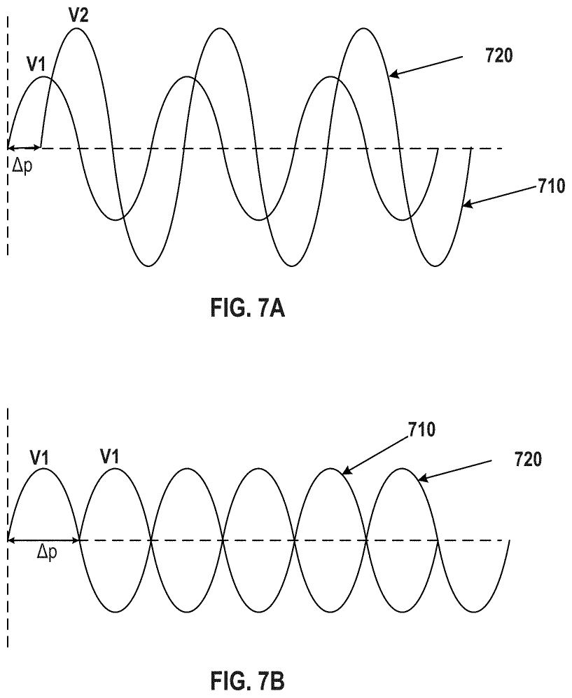

The electrical signals used for driving the piezoelectric actuators (e.g., 304 and 305) may take many forms and may have various relationships between each other or among one another. For example, FIG. 7A shows exemplary waveforms of a first electrical signal 710 and a second electrical signal 720. As shown in FIG. 7A, both electrical signals 710 and 720 are sinusoidal AC signals. In some embodiments, the amplitude and/or the phase may be varied (e.g., through a controller) to alter a vibration manner of the piezoelectric actuators, thereby controlling the tilting motion of micro mirror 302. The difference in signal amplitude and/or phase may cause piezoelectric actuators 304 and 305 to vibrate in a particular manner. For example, signal 710 has an amplitude V1 and signal 720 has an amplitude V2. As shown in FIG. 7A, V2 is greater than V1. In addition, signals 710 and 720 have a 90-degree (Δp=π/2) phase offset. FIG. 7B shows another example where signals 710 and 720 have a 180-degree (Δp=π) phase offset but the same amplitude V1. This signal configuration can generate a balanced vibrating motion with the maximum force, thereby causing micro mirror 302 to tilt equally to both sides with the maximum degree. It is understood that other signal configurations may be used to control the motion of micro mirror 302. The control of voltage signals (e.g., 710, 720) may be achieved by a controller operatively coupled to actuators 304 and 305. In addition, the frequency of voltage signals 710 and 720 may be set to a frequency that is the same as the resonant frequency of micro mirror 302, so as to achieve the maximum driving efficiency.

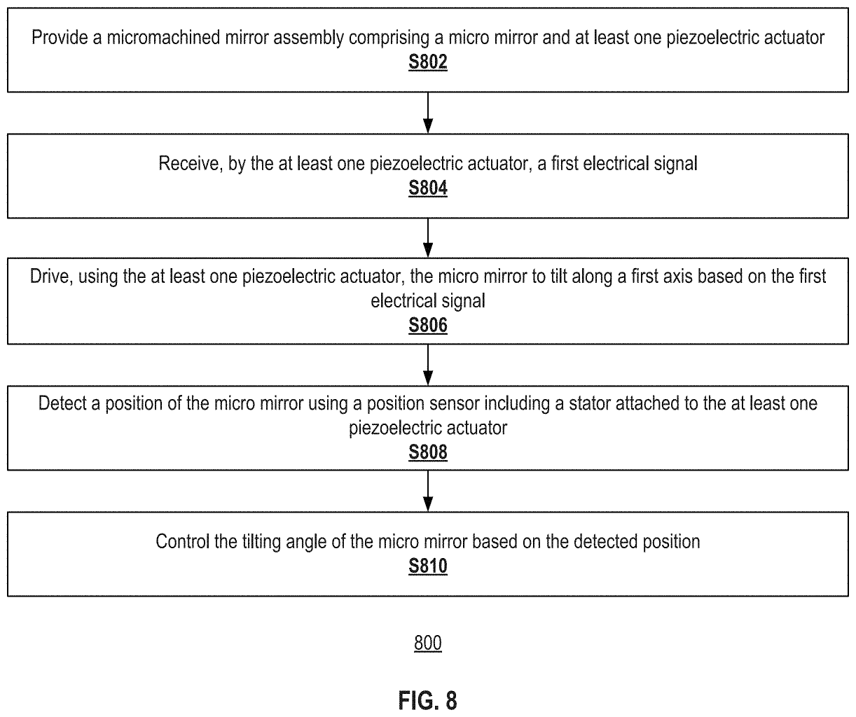

FIG. 8 illustrates a flow chart of an exemplary method 800 for controlling directions of optical signals within a micromachined mirror assembly, according to embodiments of the disclosure. It is to be appreciated that some of the steps may be optional. Further, some of the steps may be performed simultaneously, or in a different order than shown in FIG. 8.

In step S802, a micromachined mirror assembly (e.g., micromachined mirror assembly 300) is provided. The micromachined mirror assembly may include a micro mirror (e.g., micro mirror 302) and at least one piezoelectric actuator (e.g., piezoelectric actuator 304/305). The micro mirror may be suspended over a substrate (e.g., substrate 320) by at least one beam (e.g., beam 307/311) mechanically coupled to the micro mirror. The at least one piezoelectric actuator may be mechanically coupled to the at least one beam. In some embodiments, the micro mirror may be suspended over the substrate by two beams (e.g., beams 307 and 311) mechanically coupled to the micro mirror, with one of the beams mechanically coupled to one end of the micro mirror, and the other beam mechanically coupled to an opposite end of the micro mirror. In some embodiments, the at least one piezoelectric actuator may include two piezoelectric actuators (e.g., piezoelectric actuators 304 and 305), with one piezoelectric actuator mechanically coupled to one beam and the other piezoelectric actuator mechanically coupled to the other beam.

In step S804, the at least one piezoelectric actuator receives a first electrical signal (e.g., signal 710 shown in FIGS. 7A and 7B). In some embodiments, multiple piezoelectric actuators may be used. Each piezoelectric actuator may receive a respective electrical signal (e.g., piezoelectric actuator 304 receives signal 710 and piezoelectric actuator 305 receives signal 720 as shown in FIGS. 7A and 7B). The first and second electric signals may have the same frequency that is equal to a resonant frequency of the micro mirror. In some embodiments, the first and second electrical signals are different in at least one of amplitude or phase, as discussed above in connection with FIGS. 7A and 7B.

In step S806, the at least one piezoelectric actuator is used to drive the micro mirror to tilt around a first axis (e.g., axis 309) based on the first electrical signal. For example, electrical signal 710 shown in FIG. 7A may cause the piezoelectric material of piezoelectric actuator 304 to expand or shrink in a first direction parallel to axis 309, perpendicular to the direction of the electric field caused by the first electrical signal. Piezoelectric actuator 304 may thus bend in a second direction perpendicular to the first direction. The bending movements can be transferred to anchors 308 and 310, causing the anchors to tilt, which in turn causes beams 307 and 311 to rotate (e.g., twist) around axis 309. The rotation of beams 307 and 311 drives micro mirror 302 to tilt around axis 309. In some embodiments, multiple sets of piezoelectric actuators may be used to tilt the micro mirror around multiple axes, as discussed above in connection with FIG. 6.

In step S808, a position sensor (e.g., position sensor 306) may detect a position of the micro mirror. The position sensor may include a stator (e.g., stator 322) attached to the at least one piezoelectric actuator (e.g., piezoelectric actuator 304/305). The position sensor may include a comb structure (e.g., comb structure 324) including a plurality of teeth interleaved with a corresponding plurality of teeth on the micro mirror, as discussed above in connection with FIGS. 3A and 3B.

In step S810, the tilting angle of micro mirror 302 may be controlled based on the position of micro mirror 302 detected by position sensor 306. For example, the controlled tilting angle of micro mirror 302 may be used to control the refection direction of the incident light and thus be used to scan different FOVs.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A micromachined mirror assembly for controlling directions of optical signals in an optical sensing system, the micromachined mirror assembly comprising:
a micro mirror suspended over a substrate by at least one beam mechanically coupled to the micro mirror; and
at least one piezoelectric actuator mechanically coupled to the at least one beam and configured to drive the micro mirror via the at least one beam,
wherein the at least one piezoelectric actuator is configured to drive the micro mirror to tilt around a first axis based on a first electrical signal applied to the at least one piezoelectric actuator, wherein the first electrical signal causes a piezoelectric material of the at least one piezoelectric actuator to expand in a first direction in parallel with the first axis.

2. The micromachined mirror assembly of claim 1, wherein the piezoelectric actuator bends in a second direction perpendicular to the first direction.

3. The micromachined mirror assembly of claim 1, wherein the first electrical signal causes an electrical field in the piezoelectric material perpendicular to the first direction.

4. The micromachined mirror assembly of claim 1, wherein the at least one piezoelectric actuator is at least one of a unimorph piezoelectric actuator or a bimorph piezoelectric actuator.

5. The micromachined mirror assembly of claim 1, wherein:
the at least one beam comprises a first beam and a second beam, the first beam being mechanically coupled to one side of the micro mirror and the second beam being mechanically coupled to an opposite side of the micro mirror, and
the at least one piezoelectric actuator is mechanically coupled to the first and second beams.

6. The micromachined mirror assembly of claim 1, wherein:
the at least one piezoelectric actuator comprises a first piezoelectric actuator and a second piezoelectric actuator,
the first piezoelectric actuator is configured to receive the first electrical signal, and
the second piezoelectric actuator is configured to receive a second electrical signal, wherein the first and second electrical signals have a same frequency.

7. The micromachined mirror assembly of claim 6, wherein:
the frequency of the first or second electrical signal is equal to a resonant frequency of the micro mirror.

8. The micromachined mirror assembly of claim 6, wherein:
the first and second electrical signals are different in at least one of amplitude or phase.

9. The micromachined mirror assembly of claim 6, wherein:
the first and second piezoelectric actuators bend in different directions caused by the first and second electrical signals.

10. The micromachined mirror assembly of claim 1, wherein:
the at least one piezoelectric actuator is rigidly coupled to at least one anchor,
the at least one anchor is mechanically coupled to the at least one beam, and
the at least one piezoelectric actuator is configured to drive the micro mirror by causing a displacement of the at least one anchor based on the first electrical signal.

11. The micromachined mirror assembly of claim 10, wherein:
the at least one piezoelectric actuator and the at least one anchor are both disposed on the substrate.

12. The micromachined mirror assembly of claim 1, wherein:
the at least one piezoelectric actuator comprises a first set of piezoelectric actuators and a second set of piezoelectric actuators,
the first set of piezoelectric actuators are configured to drive the micro mirror to tilt around the first axis, and
the second set of piezoelectric actuators are configured to drive the micro mirror to tilt around a second axis.

13. A method for controlling a micromachined mirror assembly, comprising:
suspending a micro mirror over a substrate by at least one beam mechanically coupled to the micro mirror;
mechanically coupling at least one piezoelectric actuator to the at least one beam; and
applying a first electrical signal to the at least one piezoelectric actuator to cause a piezoelectric material of the at least one piezoelectric actuator to expand in a first direction in parallel with the first axis.

14. The method of claim 13, wherein the piezoelectric actuator bends in a second direction perpendicular to the first direction.

15. The method of claim 13, wherein:
the at least one beam comprises a first beam and a second beam, the first beam being mechanically coupled to one side of the micro mirror and the second beam being mechanically coupled to an opposite side of the micro mirror,
the at least one piezoelectric actuator comprises a first piezoelectric actuator and a second piezoelectric actuator, each mechanically coupled to the first and second beams, and
the method further comprises:
applying the first electrical signal to the first piezoelectric actuator; and
applying a second electrical signal to the second piezoelectric actuator, the second electrical signal having a same frequency as the first electrical signal.

16. The method of claim 13, wherein the at least one piezoelectric actuator is rigidly coupled to at least one anchor mechanically coupled to the at least one beam,
wherein applying the first electrical signal to the at least one piezoelectric actuator further causes a displacement of the at least one anchor based on the first electrical signal

17. An optical sensing system, comprising:
a transmitter configured to emit optical signals in a plurality of directions;
a receiver configured to detect reflected optical signals; and
a micromachined mirror assembly configured to control the directions of the emitted optical signals, the mirror assembly comprising:
a micro mirror suspended over a substrate by at least one beam mechanically coupled to the micro mirror; and
at least one piezoelectric actuator mechanically coupled to the at least one beam and configured to drive the micro mirror via the at least one beam,
wherein the at least one piezoelectric actuator is configured to drive the micro mirror to tilt around a first axis based on a first electrical signal applied to the at least one piezoelectric actuator, wherein the first electrical signal causes a piezoelectric material of the at least one piezoelectric actuator to expand in a first direction in parallel with the first axis.

18. The optical sensing system of claim 17, wherein the piezoelectric actuator bends in a second direction perpendicular to the first direction.

19. The optical sensing system of claim 17, wherein the first electrical signal causes an electrical field in the piezoelectric material perpendicular to the first direction.

20. The optical sensing system of claim 17, wherein:
the at least one beam comprises a first beam and a second beam, the first beam being mechanically coupled to one side of the micro mirror and the second beam being mechanically coupled to an opposite side of the micro mirror, and
the at least one piezoelectric actuator is mechanically coupled to the first and second beams.
